(19) United States
(12) Patent Application Publication
(10) Pub. No.: US 2013/0245987 A1
(43) Pub. Date: Sep. 19, 2013

(54) STATE DETECTION DEVICE, ELECTRONIC APPARATUS, MEASUREMENT SYSTEM AND PROGRAM

(71) Applicant: SEIKO EPSON CORPORATION, Tokyo (JP)

(72) Inventors: Masamichi IZUMIDA, Ryugasaki-shi (JP); Masaki GOMI, Hino-shi (JP)

(73) Assignee: SEIKO EPSON CORPORATION, Tokyo (JP)

(21) Appl. No.: 13/793,205

(22) Filed: Mar. 11, 2013

(30) Foreign Application Priority Data
Mar. 15, 2012 (JP) 2012-058203

(51) Int. Cl. G01P 15/18; G01P 3/00

(52) U.S. Cl. CPC G01P 15/18; G01P 3/00
USPC 702/141

(57) ABSTRACT

A state detection device includes an acquisition part that acquires a detected acceleration from an acceleration sensor; an angle information calculation part that calculates, based on a first acceleration vector representing the detected acceleration obtained at a first timing and a second acceleration vector representing the detected acceleration obtained at a second timing, angle information corresponding to an angle defined by the first acceleration vector and the second acceleration vector; and an information acquisition part that acquires movement state information based on the angle information.

The present application claims a priority based on Japanese Patent Application No. 2012-058203 filed on Mar. 15, 2012, the contents of which are incorporated herein by reference.

### BACKGROUND

1. Technical Field

The present invention relates to state detection devices, electronic apparatuses, measurement systems and programs.

2. Related Art

There are generally two major approaches that have been implemented for a device that measures walking and running states, and calculates moved distance and moving speed.

As the first approach, there is a method in which distance information or speed information is acquired from outside, besides information concerning the state of the user as to whether the user is walking or running, and the measurement of walking or running state is corrected. A method of using a measurement system such as GPS (Global Positioning System) and a method of using IC tag (RFID: Radio Frequency Identification) can be enumerated as typical concrete examples of the first approach.

As the second approach, there are methods in which physical information such as acceleration associated with walking or running is obtained in greater detail, and speed and distance are assumed with the pace being corrected or regardless of the pace. Although there are a variety of methods in the second approach, the second approach can be further classified into the following two approaches, an approach A and an approach B.
First, the approach A will be described. Walking or running of a human can be ideally first-approximated as uniform movement. In effect, because each step has a speed changing cycle, acceleration is not non-existent. In fact, the change in the acceleration is not large at all from the point of view of shift of the body weight. However, as for the foot, it is understood that the foot repeats movements while running, in which the foot is swung ahead of the body's center of gravity, contacted on the ground, and kicked backward. In this manner, the foot cyclically repeats acceleration movements greatly different from that of the center of gravity of the body, so that the pace or the like can be measured through measuring the movements of the foot. Note that because of the arm's swinging movements, the hand has cyclical acceleration movements though they are not as much as those of the foot. Therefore, in using the approach A, the pace or the like is accurately assumed with a measurement device attached to the hand or the foot, whereby the accuracy in measurement of the speed and the distance can be improved.

In contrast, the approach B attempts to calculate the speed and the distance with a measurement device mounted on a body part other than the hand and the foot, such as, for example, on the chest or the waist. As the chest and the waist are close to the body's center of gravity, their acceleration movements are not clearly defined, compared to those of the foot and the hand because of the reason described above. Though sufficient vibration exists to enable detection of each step, the pace cannot be directly measured by the approach B, as can be done with the foot. In this respect, many measuring methods have been designed for the improvement of the accuracy, such as, a method of related art described in JP-A-2008-292294 (Patent Document 1).

In the first approach, there are problems in that, first, the speed cannot be assumed in places where an external infrastructure does not exist or cannot be used (for example, in a room in the case of a GPS); second, frequent wireless communications with the outside are necessary; third, the power consumption is large so that the battery life tends to become too short; and fourth, errors are large when running in a small area.

On the other hand, the approach A among the second approaches does not have the first to fourth problems described above. However, when a foot pod type device that is installed on the foot is used, a sensor needs to be attached to the foot, independently of a heart rate monitor to be mounted on the chest and a display device on the chest, which is troublesome because the user's convenience is spoiled.

Furthermore, although the above-described Patent Document 1 that uses the approach B does not have the first to fourth problems described above, similarly to the approach A, square root operations are necessary to generate acceleration synthesis vectors, and division is further required to obtain an average value. Therefore, this method entails a problem in that the computational complexity is large for the assumption accuracy achieved.

### SUMMARY

In accordance with an aspect of the invention, there is provided a method for assuming a moving speed and a moved distance of the user with high assumption accuracy based on the approach B among the second approach.

In accordance with some other aspects of the invention, a state detection device, an electronic apparatus, a measurement system and a program, which are capable of assuming the moving speed and the like through measurement of acceleration.

An embodiment of the invention pertains to a state detection device including an acquisition part that acquires detected acceleration from an acceleration sensor, an angle information calculation part that calculates, based on a first acceleration vector representing the detected acceleration obtained at a first timing and a second acceleration vector representing the detected acceleration obtained at a second timing, angle information corresponding to an angle defined by the first acceleration vector and the second acceleration vector, and an information acquisition part that acquires movement state information based on the angle information.

According to the embodiment of the invention, angle information is calculated based on acceleration vectors representing two detected acceleration values acquired at different timings, and movement state information is acquired based on the angle information obtained. As a result, for example, movement state information can be obtained without processing to extract coordinate axis components in a specific direction from the detected acceleration values.

In accordance with an aspect of the embodiment, the information acquisition part may obtain a speed assumption value as the movement state information based on the angle information.

As a result, based on angle information, speed assumption values that are readily understandable by the user can be calculated as movement state information.

In accordance with an aspect of the embodiment, the information acquisition part may obtain angle information to be integrated based on the angle information corresponding to the detected acceleration obtained in a predetermined period, perform an integration processing on the obtained angle information to be integrated to obtain integrated angle information, and obtain the speed assumption value as the movement state information based on the integrated angle information.

As a result, for example, errors in the speed assumption values can be suppressed even when the user's body is jolted right and left while moving.

In accordance with an aspect of the embodiment, the information acquisition part may compare a change per unit time of the integrated angle information with a predetermined threshold value to judge the state of movement of the user, thereby obtaining the movement state information representing the state of movement.

Accordingly, the state of movement can be judged by, for example, judging as to whether an inclination of a graph that plots integrated angles associated with the integrated angle information along a vertical axis and the time along a horizontal axis is greater than a predetermined threshold value.

In accordance with an aspect of the embodiment, the information acquisition part may perform the integration processing on the angle information to be integrated obtained based on the detected acceleration obtained within the predetermined period that is longer than 2Tᵤ, where Tᵤ is a step interval of the user.

As a result, the angle information to be integrated is obtained based on the detected acceleration that can be obtained within a period of time that can include at least 2 cycles, one cycle being one left or right step.

In accordance with an aspect of the embodiment, the information acquisition part may obtain, at a speed assumption timing M1, integrated angle information θ_{M1} from the sum total of integrated angle information θ_{T1}-θ_{Ti} obtained respectively at preceding speed assumption timings T1-Ti (i is a positive integer of two or more), and may obtain, at a speed assumption timing M2, integrated angle information θ_{M2} from the sum total of integrated angle information θ_{T2}-θ_{T (i+1)} obtained respectively at preceding speed assumption timings T2-T(i+1).

As a result, a hysteresis characteristic can be given to the speed assumption value.

In accordance with an aspect of the embodiment, the information acquisition part may obtain the speed assumption value V_{d} as the movement state information by a relational expression of V_{d}=aθₛᵤₘ+b (coefficient a and constant b are predetermined real numbers), where θₛᵤₘ is the integrated angle information, and V_{d} is the speed assumption value.

As a result, the speed assumption value can be obtained based on a linear expression of integrated angle information.

In accordance with an aspect of the embodiment, the state detection device may include a storage part that stores the coefficient a and the constant b obtained from measured values, and the information acquisition part may obtain the speed assumption value V_{d} based on the coefficient a and the constant b read out from the storage part.

Accordingly, for example, variations in the speed assumption value among multiple users can be suppressed.

In accordance with an aspect of the embodiment, the information acquisition part may judge a movement state of the user based on the angle information, obtain the movement state information representing the state of movement, and switch the coefficient a and the constant b to be used, according to the obtained movement state information.

Accordingly, for example, variations in the speed assumption accuracy among different states of movement can be suppressed.

In accordance with an aspect of the embodiment, the state detection device may include a calibration processing part that performs calibration processing based on measured speed values, and the information acquisition part may change at least one of the coefficient a and the constant b based on the result of the calibration processing.

As a result, the state detection device in accordance with the embodiment of the invention can determine the coefficient a and the constant b without depending on an external device, for example.

In accordance with another embodiment of the invention, an electronic apparatus includes the state detection device and the acceleration sensor described above.

In accordance with still another embodiment of the invention, a measurement system includes the state detection device described above.

As a result, for example, a portion of the processings performed by the state detection device can be executed by a server, so that the amount of processing of the state detection device can be reduced.

Furthermore, another embodiment of the invention pertains to a program that renders a computer to function as each of the parts described above.

### BRIEF DESCRIPTION OF THE DRAWINGS

FIGS. 1A and 1B show an exemplary system configuration in accordance with an embodiment of the invention.

FIG. 2 is a chart for explaining the outline of a speed assumption processing.

FIG. 3 shows a view for explaining angles defined between a first acceleration vector and a second acceleration vector.

FIG. 4 is a graph showing a locus that connects the tips of acceleration vectors.

FIG. 5 is a graph showing the relation between integrated angles and measured speed values.

FIG. 6 is a diagram for explaining a moving average processing.

FIGS. 7A and 7B are graphs for explaining acceleration vectors with respect to states of movement.

FIG. 8 is a graph showing integrated angles to sampling timings.

FIGS. 9A and 9B show an implementation example in accordance with an embodiment of the invention.

FIG. 10 is a flow chart for explaining a processing flow in accordance with an embodiment of the invention.

### PREFERRED EMBODIMENTS

Embodiments of the invention are described below. First, a summary of an embodiment of the invention will be described, and then a system configuration example in accordance with an embodiment of the invention will be described. Third, a method in accordance with an embodiment of the invention will be described in detail, referring to concrete examples. Lastly, a process flow in accordance with an embodiment of the invention will be described using a flow chart. It is noted that the embodiments described below do not unduly limit the contents of the invention set forth in the scope of patent claims. Also, not all of the compositions described in the embodiments would necessarily be essential components.

### 1. Summary

An approximate distance d can be obtained by multiplying the pace p and the number of steps h, as shown in Expression (1) below. This is the relation between walking or running of a human and the distance, which has been known since B.C.

[Expression 1]

d=p*h (1)

A measurement method to calculate a distance by multiplying one step distance with the number of steps (for example, when a person walks 10 steps and each step measures 60 cm, an approximate moved distance is 6 m) is often used even now, and the use of “steps” in the measurement of the area of land in ancient time appears in an ancient Chinese literature.

By measuring the time t for an object to move over the distance d, the moving speed v can be obtained as shown in Expression (2) below.

$$\begin{matrix}[ Expression 2 ] & \\ v = \frac{d}{t} & ( 2 )\end{matrix}$$

However, it is also true that the measuring method described above accompanies a large error. This is due to the fact that the human pace p is not necessarily constant.

Considering the fact that one right step and one left step are often different from each other, it would be more accurate to calculate the distance, etc. based on one cycle width w where w is the sum of the pace of the left foot P_{left} and the pace of the right foot P_{right}, as shown in Expression (3) below.

[Expression 3]

w=p_{left}+p_{right} (3)

For this reason, there are generally two major approaches that have been implemented for a device that measures walking and running states, and calculates the distance and the speed.

As the first approach, there is a method in which distance information or speed information is acquired from outside, independently of information concerning the state of the user if the user is walking or running, and the measurement of walking or running state is corrected. As typical concrete examples of the first approach A, a method of using a measurement system such as GPS (Global Positioning System) and a method of using IC tag (RFID: Radio Frequency Identification) can be enumerated.

As the second approach, there are methods in which physical information such as acceleration associated with walking or running is obtained in greater detail, and the speed and the distance are assumed while correcting the pace or regardless of the pace. Although there are a variety of methods in the second approach, the second approach can be further classified into the following two approaches, an approach A and an approach B.

First, the approach A will be described. Walking or running of a human can be ideally first-approximated as uniform movement. In effect, because each step has a speed changing cycle, acceleration is not non-existent. In fact, the change in the acceleration is not that large from the point of view of shift of the body weight. However, as for the foot, it is understood that the foot repeats movements while running, in which the foot is swung ahead of the body's center of gravity, contacted on the ground, and kicked backward. In this manner, the foot cyclically repeats acceleration movements greatly different from that of the body's center of gravity, so that the pace or the like can be measured through measuring the movements of the foot. Note that because of the arm's swinging movements, the hand has cyclical acceleration movements though they are not as much as those of the foot. Therefore, in using the approach A, the pace or the like is accurately assumed with a measurement device attached to the hand or the foot, whereby the measurement accuracy of the speed and the distance can be improved.

In contrast, the approach B attempts to calculate the speed and the distance with a measurement device installed on a body part other than the hand and the foot, such as, for example, on the chest or the waist. As the chest and the waist are close to the body's center of gravity, their acceleration movements are not clearly defined, compared to those of the foot and the hand because of the reason described above. Though sufficient vibration exists to enable detection of each step, the pace cannot be directly measured by the approach B, as can be done with the foot. In this respect, many measuring methods have been designed for the improvement of the accuracy, such as, a method of related art in Patent Document 1 described above.

Next, problems in each of the approaches will be described. In the first approach, there are problems in that, first, the speed cannot be assumed in places where an external infrastructure does not exist or cannot be used (for example, in a room in the case of a GPS); second, frequent wireless communications with the outside are necessary; third, the power consumption is large so that the battery life tends to become too short; and fourth, errors are large when running in a small area.

On the other hand, the approach A among the second approaches does not have the first to fourth problems described above. However, when a foot pod type device that is put on the foot is used, a sensor needs to be attached to the foot, independently of a heart rate monitor to be put on the chest and a display device on the chest, which is problematical as the user's convenience is spoiled.

Furthermore, although the above-described Patent Document 1 that uses the approach B does not have the first to fourth problems described above, similarly to the approach A, square root operations are necessary to generate acceleration synthesis vectors, and division is further required to obtain an average value. Therefore, this method entails a problem in that the computational complexity is large with respect to the assumption accuracy.

In view of the above, the inventor proposes a device for assuming a moving speed and a moved distance of the user with high assumption accuracy based on the approach B among the second approach. In accordance with an embodiment of the invention, a state detection device is provided which is to be attached to a portion other than the hand or the foot of the user. The device is capable of assuming the moving speed and the like with high accuracy through acceleration measurement.

Various techniques have been designed to obtain moving speed through acceleration measurement in the past as describe above. However, first of all, the present embodiment is characterized in that speed assumption processing highly compatible with acceleration detected by a three-axis acceleration sensor can be performed, which is not found in the other related art techniques.

Secondly, the present embodiment is characterized in that the characteristic of the way of walking or running of each individual can be extracted, and such characteristic can be strongly reflected in the assumption result. Therefore, it is possible to grasp changes in the running form.

Thirdly, the embodiment is characterized in that the moving speed and the like can be assumed, independently of the number of steps, the step stride, the walking pitch and the like. Moreover, the number of steps, the step stride, the walking pitch and the like can be used for correction of the result of assumed speed.

### 2. System Configuration Example

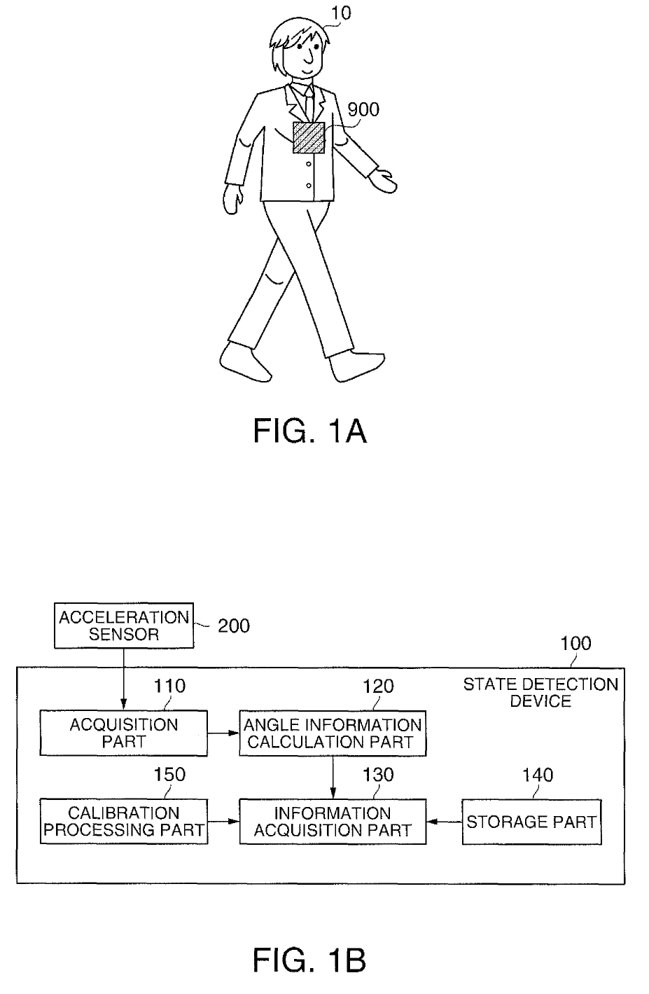

FIG. 1A shows an example in which the user 10 has put an electronic apparatus 900 including a state detection device in accordance with an embodiment of the invention on the chest. It is noted that the electronic apparatus 900, though mounted on the chest in FIG. 1A, may be placed at any position other than the chest, as long as it is mounted on a portion other than the hand and the foot.

Next, a detailed configuration example of the state detection device 100 of the embodiment and the electronic equipment 900 (or a measurement system) including the state detection device 100 is shown in FIG. 1B.

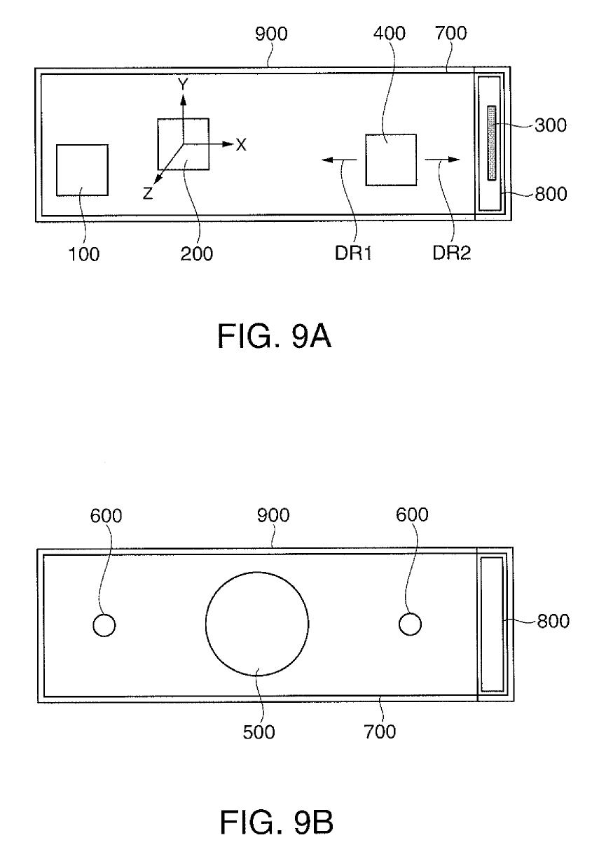

The state detection device 100 includes an acquisition part 110, an angle information calculation part 120, an information calculation part 130, a storage part 140, and a calibration processing part 150. As examples of the electronic apparatus 900 including the state detection device 100, an acceleration sensor 200, a pedometer that includes an antenna part 300, a wireless communication part 400, etc. shown in FIG. 9A to be described below may be enumerated.

It is noted that the state detection device 100 and the electronic apparatus 900 including the state detection device 100 are not limited to the configuration shown in FIG. 1B, and various modifications can be made. For example, a part of the components thereof may be omitted, or other components may be added. Moreover, a part or all of the functions of the state detection device 100 of the present embodiment may be achieved by a server connected through the antenna part 300 the wireless communication part 400 and a communication system.

Next, the processing performed by each of the parts will be described.

The acquisition part 110 acquires a detected acceleration value from the acceleration sensor 200. The acquisition part 110 is an interface part to communicate with the acceleration sensor 200, and may use a bus or the like.

The angle information calculation part 120 calculates angle information that expresses an angle defined by two acceleration vectors detected at different timings.

The information acquisition part 130 acquires movement state information (to be described below) based on the angle information.

The storage part 150 stores information such as coefficients and the like to be used to obtain speed assumption values, and provides a work area for each of the parts. The function of the storage part 150 may be achieved by a memory such as a RAM and a HDD (Hard Disk Drive).

The calibration processing part 150 performs calibration processing to be described later based on a speed measurement value.

It is noted that the angle information calculation part 120, the information acquisition part 130, and the calibration processing part 150 can be achieved by hardware, such as, various processors (CPU, etc.) and ASIC (gate array, etc.) and programs.

Further, the acceleration sensor 200 is formed from elements or the like whose resistance value increase or decrease by external force, and detects acceleration information on three axes. However, the number of axes of the acceleration sensors 200 in the embodiment is not limited to three axes.

### 3. Method in Accordance with Embodiment

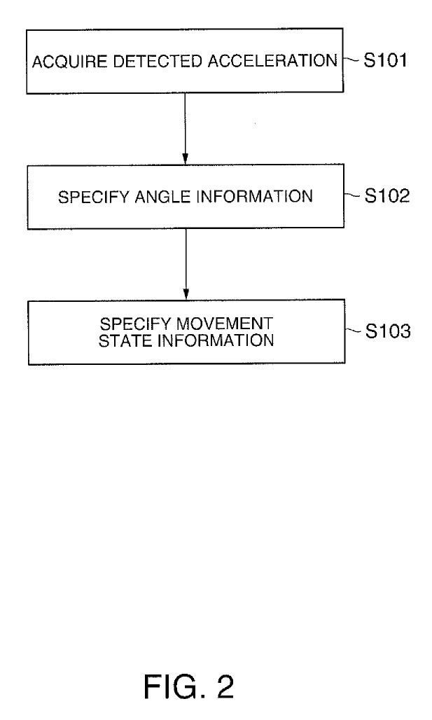

First, data that are acquired in the state detection processing in accordance with the embodiment are sequentially shown in FIG. 2. Detected acceleration is acquired from the acceleration sensor 200 in the beginning in the present embodiment (S101). Next, angle information to be described later is specified based on the acquired detected acceleration (S102), and movement state information to be described later is calculated based on the specified angle information (S103). Roughly speaking, in accordance with the embodiment, moving speed (or, moved distance), etc. of the user, which are the object of the embodiment, are obtained through such intermediate values. Hereafter, the method in accordance with the embodiment will be described in detail.

The State detection device 100 of the embodiment includes an acquisition part 110 that acquires detected acceleration from the acceleration sensor 200; an angle information calculation part 120 that calculates, based on a first acceleration vector representing detected acceleration obtained at a first timing and a second acceleration vector representing detected acceleration obtained at a second timing, angle information representing an angle defined by the first acceleration vector and the second acceleration vector; and an information acquisition part 130 that acquires movement state information based on the angle information.

Here, the detected acceleration refers to an acceleration detected with the acceleration sensor 200. For example, when the acceleration sensor 200 detects acceleration on three axes (X axis, Y axis and Z axis), the detected acceleration is expressed by a vector A shown in Expression (4) below. In Expression (4), x is an X axis component, y is a Y axis component, and z is a Z axis component. However, the detected acceleration may be mathematically expressed by any form equivalent to this expression.

$$\begin{matrix}[ Expression 4 ] & \\ A = ( \begin{matrix}x \\ y \\ z\end{matrix} ) & ( 4 )\end{matrix}$$

Note that the first timing refers to an acceleration detection timing different from the second timing. The description below will be made on the assumption that, for example, the first timing is an acceleration detection timing immediately prior to the second timing, and such a relation is established. However, the relation between the first timing and the second timing is not limited to this example. It is noted that the acceleration detection timing may be set with a constant cycle, or may be specified each time by the acceleration sensor or the like.

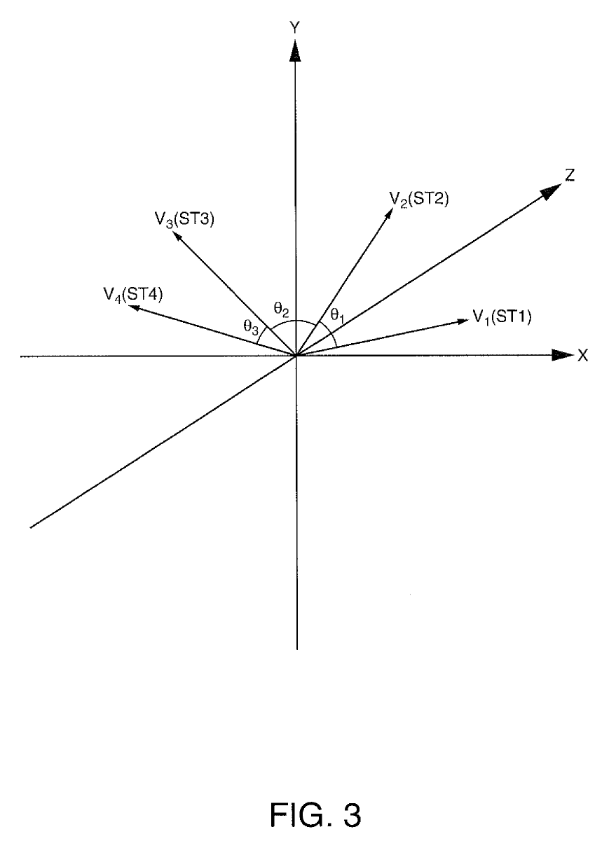

FIG. 3 is a graph showing an example of the first acceleration vector and the second acceleration vector, and angles defined by the first acceleration vector and the second acceleration vector. The graph of FIG. 3 shows acceleration vectors actually measured when the user is running in the axis direction as indicated by an arrow, and time ST1-time ST4 each being the time of acceleration detection timing.

Also, the acceleration vector V at time ST1 is V₁, the acceleration vector V at time ST2 is V₂, the acceleration vector V at time ST3 is V₃ and the acceleration vector V at time ST4 is V₄.

For example, at time ST2 shown in FIG. 3, the second timing is time ST2, and the second acceleration vector is V₂, and the first timing is an acceleration detection timing prior to the second timing which is time ST1, and the first acceleration vector is V₁. Then, an angle defined between the first acceleration vector V₁ and the second acceleration vector V₂ is obtained as θ₁.

Meanwhile, at time ST3 shown in FIG. 3, the second timing is time ST3, and the second acceleration vector is V₃, and the first timing is an acceleration detection timing prior to the second timing which is time ST2, and the first acceleration vector is V₂. Then, an angle defined between the first acceleration vector V₂ and the second acceleration vector V₃ is obtained as θ₂.

The angle information refers to an angle defined between the first acceleration vector and the second acceleration vector. For example, the angle information may refer to an angle θ₁, an angle θ₂, and an angle θ₃ in FIG. 3. However, the angle information is not limited to this, but may be information equivalent thereto or information that can be mathematically approximated. For example, when the angle information is calculated by software (hereinafter also including firmware), an approximation value of the actual angle may be obtained as the angle information, using floating point numbers, or a value indicative of the angle may be obtained as the angle information, using fixed point numbers. Note that a floating point number is a number that is represented by one of the methods of representing an approximation value of a real number on a computer, and a number represented by a method of representing a numerical value having a significand part and an exponent part each having a fixed length. On the other hand, the fixed point number is a number that is represented by one of the methods of representing an approximation value of a real number on a computer, and a number represented by a method of representing a numerical value where the number of bits reserved for the integer part and the number of bits reserved for the fractional part are fixed in advance. In other words, when angle information is calculated by software using floating point numbers, the resolution of numerical values that can be handled changes according to the computing power, the specification, etc. of the hardware, such as DSP or the like, and the angle may be obtained as an approximate value including an error corresponding to the resolution, but this approximation value may be treated as angle information. When angle information is represented by floating point numbers, the significand or the exponent part per se may be treated as angle information. However, hereunder, a numerical value (the aforementioned approximation value) represented by the significand part and the exponent part will be described as angle information. In addition, when software uses fixed point numbers, for example, fixed point numbers in which 0.5 degrees is represented as 1 and 360 degrees (2π radians) as 720 may be used as angle information. In this case, for example, 10 degrees is represented as an integer of 20, which represents the angle of 10 degrees, in light of the above-described conversion rule in which 0.5 degrees is represented as 1. Note that another conversion rule may be followed without any particular limitation to the above rule in which 0.5 degrees is represented by 1. Furthermore, an interior angle between the first acceleration vector and the second acceleration vector may also be used as angle information. The above is also applicable to angle information to be integrated and integrated angle information to be described below.

Moreover, the angle defined between the first acceleration vector and the second acceleration vector may be another angle without being limited to the example described above, as long as the angle is formed by these two vectors.

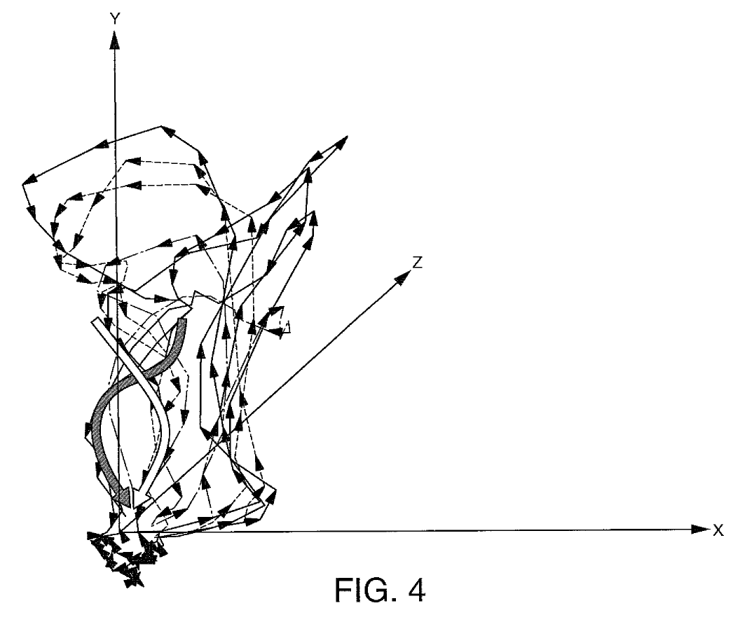

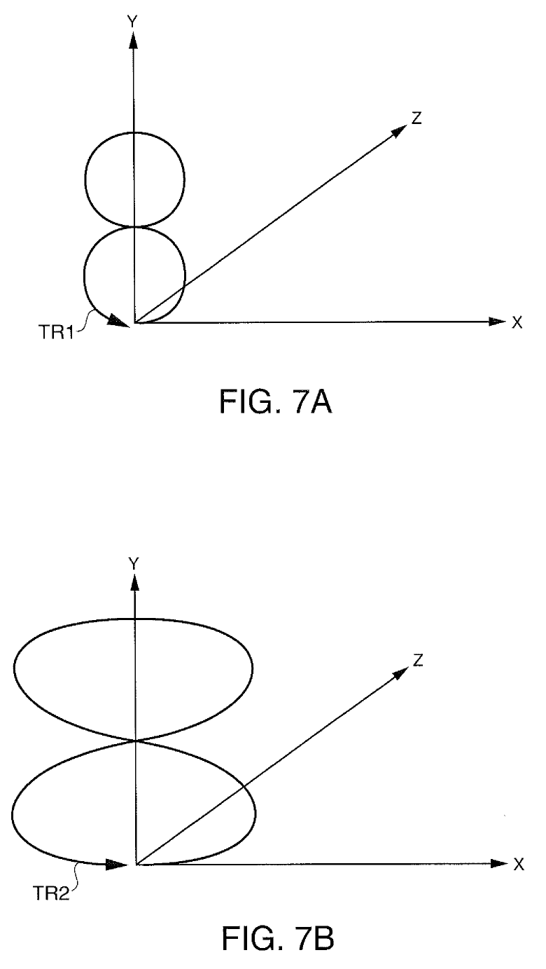

A graph in FIG. 4 is illustrated as reference. The graph of FIG. 4 shows a locus that is drawn by acceleration vectors actually measured when the user is running in the Z axis direction as indicated by an arrow. Each of arrows drawn in the graph of FIG. 4 indicates an acceleration vector detected at each of acceleration detection timings. When these acceleration vectors are continuously joined, a complex locus is drawn with a constant periodicity matching with foot swinging movements of the user at the time of running. In other words, assuming that the tip of each acceleration vector detected at an immediately prior acceleration detection timing is a starting position, the locus in the graph of FIG. 4 which is drawn by connecting an acceleration vector detected at the following acceleration detection timing to the previous one has a constant periodicity. A method of judging the state of movement using the characteristic of a locus having such a periodicity will be described later using FIGS. 7A and 7B.

Note that such angle information is calculated and acquired by the angle information calculation part 120, and then the information acquisition part 130 acquires movement state information based on the acquired angle information.

Here, the movement state information is information indicative of the state of movement of the user who puts the state detection device 100 or the electronic apparatus 900 including the state detection device 100 on a part of the body.

Also, the state of movement may be, for example, the state of the user in walking, running, or stopping. Moreover, more detailed information may be considered as the state of movement. More detailed information may be information on the moving speed or the moved distance of the user, the traveled time and the like.

Therefore, as examples of the movement state information, for example, speed assumption values and distance assumption values to be described later, travel time, information indicative of the state of movements, such as, the state in which the user is walking or running, the state in which the user is stopping, etc. may be enumerated.

As described above, the state detection device 100 of the present embodiment may be put on a part of the body of the user other than the hand or the foot to measure acceleration, whereby processings to assume the moving speed, etc. can be performed.

Moreover, as described above, in accordance with the present embodiment, the processing to extract only horizontal components from detected acceleration in three axes as was done by another method of related art is not performed, but detected acceleration in three axes are thoroughly used for processing to specify the state of movement. In other words, the speed assumption processing highly compatible with acceleration detected with a three-axis acceleration sensor is made possible.

Moreover, as described above, in accordance with the present embodiment, the processing to extract only components in a specific direction from detected acceleration in three axes is not performed, such that the characteristics of the manner of walking and running of each individual expressed in detected acceleration would not be lost. In other words, the characteristics of the manner of walking and running of each individual can be thoroughly extracted, and such characteristics can be reflected strongly in the speed assumption result. Therefore, changes in the running form, etc. as the user's state of movement can also be captured.

Next, a concrete method of acquiring movement state information will be described. It can be said that information that agrees most with the object of the embodiment among movement state information is a moving speed of the user.

Therefore, information acquisition part 130 may acquire a speed assumption value as movement state information based on angle information. More specifically, the information acquisition part 130 may acquire speed assumption value V_{d} as movement state information based on the angle θ associated with the angle information.

Here, the speed assumption value V_{d} refers to a value assumed as the moving speed of the user. Because a value whose meaning can be readily grasped at a glance is suitable as the speed assumption value V_{d}, such a value may preferably be expressed mainly in the international unit system, without any particular limitation thereto.

More specifically, the angle θ of an angle defined by an acceleration vector V₁ in Expression (5) and an acceleration vector V₂ in Expression (6) can be obtained by Expression (7). However, without any limitation to the above, it can be obtained through an operation mathematically equivalent to the above.

$$\begin{matrix}[ Expression 5 ] & \\ {V}_{1} = ( \begin{matrix}{x}_{1} \\ {y}_{1} \\ {z}_{1}\end{matrix} ) & ( 5 ) \\ [ Expression 6 ] & \\ {V}_{2} = ( \begin{matrix}{x}_{2} \\ {y}_{2} \\ {z}_{2}\end{matrix} ) & ( 6 ) \\ [ Expression 7 ] & \\ θ = arccos ( \frac{{x}_{1} {x}_{2} + {y}_{1} {y}_{2} + {z}_{1} {z}_{2}}{\sqrt{{x}_{1}^{2} + {y}_{1}^{2} + {z}_{1}^{2}} \sqrt{{x}_{2}^{2} + {y}_{2}^{2} + {z}_{2}^{2}}} ) & ( 7 )\end{matrix}$$

Note that, as described above, the angle information and the angle θ associated therewith do not necessarily match with each other. For example, when angle information is represented by a fixed point number in which 0.5 degrees is represented as an integer of 1, like the example described above, when the angle information is 10, the angle θ associated with the angle information is 5 degrees.

As a result, the speed assumption value V_{d} whose meaning can be easily grasped by the user can be calculated as movement state information based on the angle information. In other words, values that can be more easily understood by the user can be presented.

Further, details of the processing to acquire speed assumption values based on angle information will be described.

For example, when the user's body is jolted right to left while moving, it is possible that the user's body may be momentarily accelerated. In this case, if the speed assumption processing is performed only based on angle information obtained at a certain time, speed information may be erroneously assumed to be larger, compared with the case when the user's body is not jolted. Therefore, it can be expected that such an error can be prevented from occurring if not only angle information obtained at a certain time, but also plural sets of angle information obtained in a predetermined period are used for the speed assumption processing.

Therefore, the information acquisition part 130 may acquire angle information to be integrated based on angle information corresponding to detected acceleration obtained in a predetermined period, perform a processing to integrate the angle information to be integrated, and obtain speed assumption value as the movement state information based on the integrated angle information.

Further, the information acquisition part 130 may obtain the speed assumption value V_{d} as movement state information by a relational expression of V_{d}=aθₛᵤₘ+b (coefficient a and constant b are predetermined real numbers), where θₛᵤₘ is the integrated angle information, and V_{d} is the speed assumption value. Alternatively, the information acquisition part 130 may obtain the speed assumption value V_{d} in which the integrated angle θₛᵤₘ associated with (indicative of) the obtained integrated angle information satisfies the relational expression of Vd=aθₛᵤₘ+b (coefficient a and constant b are predetermined real numbers) as movement state information.

Note here that the angle information to be integrated refers to angle information subject to integration in an integration processing to be described later. It is noted that the angle information to be integrated does not necessarily correspond to its associated angle θ to be integrated.

Further, the integration processing is a processing that obtains angle information to be integrated based on angle information corresponding to the detected acceleration obtained in the predetermined period, and integrates the obtained angle information to be integrated.

For example, the integration processing will be described using an example in FIG. 3. Here, the predetermined period is assumed to include the acceleration detection timings ST1-ST4. Furthermore, the angle information and the angle, the angle information to be integrated and the angle to be integrated, and the integrated angle information and the integrated angle are deemed to be equivalent to each other, respectively. At this time, the angle information corresponding to the detected acceleration V₂ at the acceleration detection timing ST2 refers to the angle θ₁, and to obtain the angle to be integrated means to obtain the angle θ₁. Similarly, the angle information corresponding to the detected acceleration V₃ at the acceleration detection timing ST3 refers to the angle θ₂ to be integrated.

In other words, in accordance with the present embodiment, the acquisition part 110 acquires all detected acceleration values (V₁-V₄) within the predetermined period (at ST1-ST4 in the above-described example), and acquires, in the integration processing, all angles of corners (θ1, θ2, and θ3) defined between acceleration vectors obtained at adjacent acceleration detection timings (ST1 and ST2, ST2 and ST3, and ST3 and ST4) among detected acceleration obtained by the acquisition part 110, and performs a processing to integrate all of the obtained angles.

In this manner, the value obtained as a result of the integration processing refers to an integrated angle (integrated angle information). More specifically, the integrated angle θₛᵤₘ in this example is expressed by Expression (8). In Expression (8), i indicates the sample number, j is the sample beginning number, m is the number of samplings, and i, j and m are positive integers.

$$\begin{matrix}[ Expression 8 ] & \\ {θ}_{sum} = {\sum }_{j}^{j + m} {θ}_{i} & ( 8 )\end{matrix}$$

Note that the values of the integrated angle and the integrated angle information associated with the integrated angle are not necessarily corresponding to each other, similarly to the example of the angle information and the angle associated with the angle information described above.

As a result, for example, even when the user's body is jolted right to left while moving, it is possible to suppress errors from occurring in the speed assumption values.

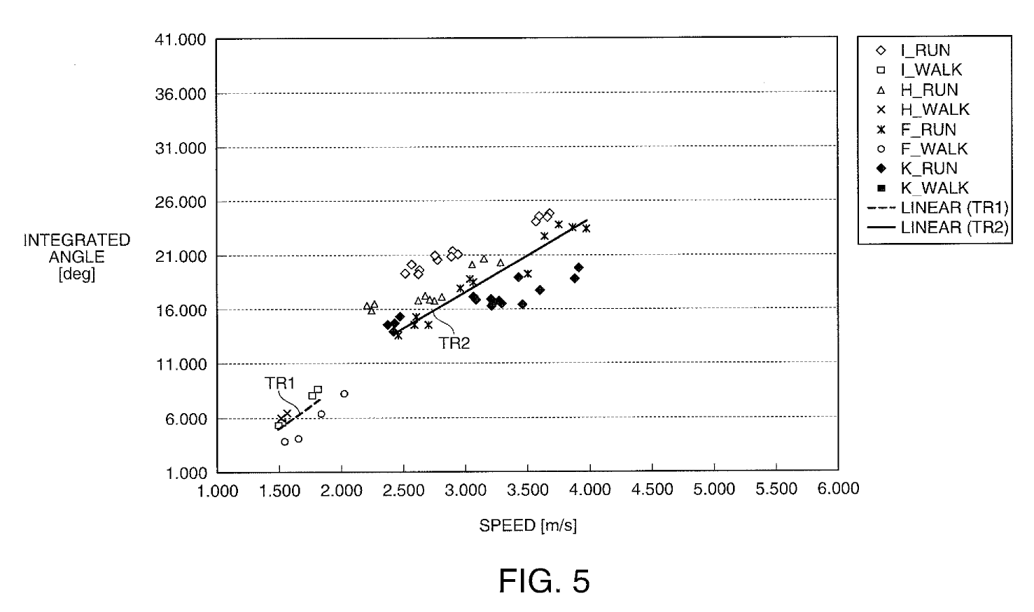

The relation between integrated angles obtained by actual experiments and measured speed values is shown in the graph in FIG. 5. The graph of FIG. 5 shows integrated angles (deg) along the vertical axis, and speeds (m/s) along the horizontal axis, and shows the relation between integrated angles obtained by the integration processing based on the detected acceleration speed detected during the predetermined period of time and the speeds actually measured. Note that the integrated angle and the speed in FIG. 5 use values in which they are converted into values per unit time, respectively. Also, each of sequential data shows data of four testees I, H, F and K when walking (I_WALK, H_WALK, F_WALK, K_WALK) and data when running (I_RUN, H_RUN, F_RUN, K_RUN). For the sake of illustration, the experimental data shows only data for four testees, but data for more testees are actually obtained.

According to the graph in FIG. 5, in both of the cases of walking and running, integrated angles per unit time and speed measurement values are (generally) in a proportional relation. In view of the correlation for each person, a high correlation with correlation coefficients of 0.98-0.99 is shown. In other words, the tendency of each of the testees can be represented by a linear line TR1 at the time of walking, and the tendency of each of the testees can be represented by a linear line TR2 at the time of running.

Therefore, it can be said that it is effective to obtain the speed assumption value from the integrated angle based on Expression (9), because the integrated angle and the speed measurement value are (generally) in such a proportional relation.

[Expression 9]

V_{d}=aθₛᵤₘ+b (9)

As a result, the speed assumption value can be obtained based on a linear equation of integrated angle information. Alternatively, the relational expression between the integrated angle information and the speed assumption value is decided based on the linear equation of the integrated angle, and the speed assumption value can be obtained based on the relational expression of the integrated angle information and the speed assumption value.

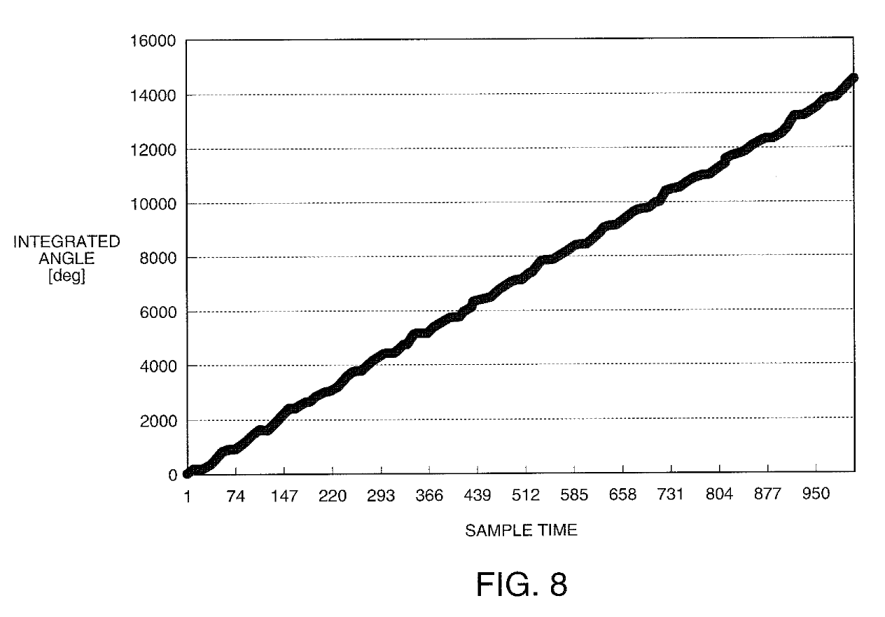

Though it is understood from the graph of FIG. 5 that the inclination of the linear line of tendency TR1 in walking and the inclination of the linear line of tendency TR2 in running are different from each other, but a method of judging the user's movement can be devised through using such a characteristic. Such a method will be described below with reference to FIGS. 7A and 7B and FIG. 8.

Moreover, how the predetermined period for detecting the detected acceleration, that is the origin of angle information to be integrated, is to be set becomes important in the above-described integration processing. Though the predetermined period may be arbitrarily set, it is preferable that the predetermined time may ideally be a period of time that can include two cycles, each one cycle assuming one left or right step. Also, the time may be obtained by measuring the running pitch to define this time, but for simplification of the processing, a period of time in which two cycles are believed to be always included in usual running, for example, 4 seconds or 8 seconds may be set as the predetermined period.

In other words, when the user's step interval is assumed to be Tᵤ, the information acquisition part 130 may perform the integration processing on angle information to be integrated obtained based on detected acceleration acquired in a predetermined period that is longer than 2Tᵤ.

As a result, assuming one right or left step to be one cycle, angle information to be integrated is obtained based on the detected acceleration acquired within the period of time that can contain at least two cycles, and the integration processing can be performed.

The acceleration might change greatly when the user's body is jolted right and left while moving, as mentioned above. It is desirable to reduce the change in the moving speed due to such a factor as much as possible. Therefore, in the embodiment, a moving average of integrated angle information, which is used when calculating the speed assumption value, is obtained to give a hysteresis characteristic to the speed assumption value.

Specifically, the information acquisition part 130 may obtain, at a speed assumption timing M1, integrated angle information θ_{M1} from the sum total of integrated angle information θ_{T1}-θ_{Ti} obtained respectively at preceding speed assumption timings T1-Ti (i is a positive integer of 2 or more), and may obtain, at a speed assumption timing M2, integrated angle information θ_{M2} from the sum total of integrated angle information θ_{T2}-θ_{T (i+1)} obtained respectively at preceding speed assumption timings T2-T(i+1).

Here, the speed assumption timing refers to a timing at which the speed assumption processing is performed. The speed assumption timing may be a timing that occurs with the same cycle as the timing at which the detected acceleration is acquired (sampling timing), or may be a timing that occurs with a cycle different from the sampling timing.

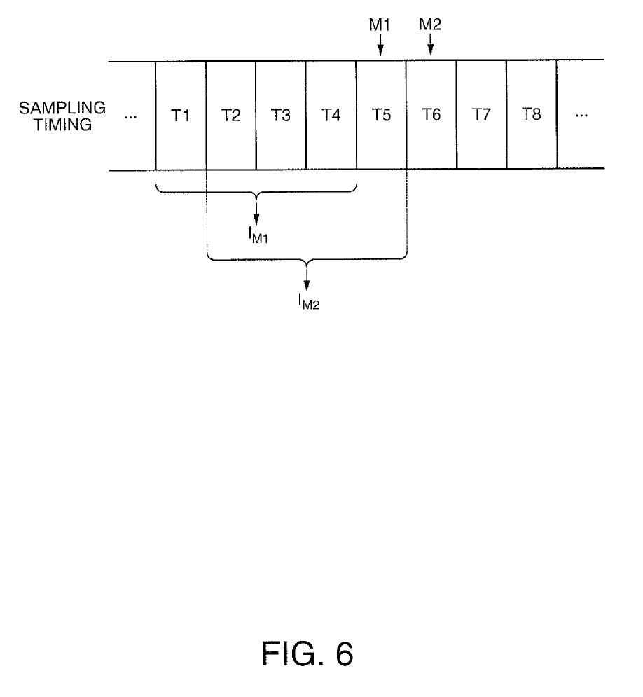

Here, a concrete example with i=4 is shown in FIG. 6. In the example of FIG. 6, for simplification of explanation, the speed assumption timing (M1 and M2) and the sampling timing are assumed to be the same timing, and occur with the same cycle. At this time, integrated angle information obtained at the speed assumption timing M1 is given by Expression (10), and integrated angle information obtained at the speed assumption timing M2 is given by Expression (11).

$$\begin{matrix}[ Expression 10 ] & \\ {θ}_{M 1} = \frac{{θ}_{T 1} + {θ}_{T 2} + {θ}_{T 3} + {θ}_{T 4}}{4} & ( 10 ) \\ [ Expression 11 ] & \\ {θ}_{M 2} = \frac{{θ}_{T 2} + {θ}_{T 3} + {θ}_{T 4} + {θ}_{T 5}}{4} & ( 11 )\end{matrix}$$

Moreover, in Expression (10) and Expression (11), division by i=4 is performed. However, the values of the coefficient a and the constant b may be adjusted without actually performing the division. The hysteresis characteristic can be given to the speed assumption value even when division is not performed, whereby unnecessary calculation can be reduced.

As a result, the hysteresis characteristic can be given to the speed assumption value. Accordingly, for example, changes in the moving speed which may be caused when the user's body is jolted right and left while moving can be suppressed.

Note that different values may preferably be set to the coefficient a and the constant b described above according to the predetermined period, etc. in which the integration processing is performed.

Moreover, values suitable for each user who uses the device may preferably be set to the coefficient a and the constant b described above. This is because actual moving speed would not necessarily become the same even when integrated angle information is the same, as the manner of how the user walks and runs differs from one user to another.

In light of the above, the state detection device 100 in accordance with the present embodiment may include a storage part 140 that stores the coefficient a and the constant b obtained from measured values. Also, the information acquisition part 130 may obtain the speed assumption value V_{d} based on the coefficient a and the constant b read out from the storage part 140.

Here, the measured values may refer to, for example, actual moving speed.

As a result, appropriate values for the coefficient a and the constant b specified based on the measurement values can be stored, and the stored coefficient a and constant b can be used when the speed assumption value is to be obtained. Accordingly, differences in the speed assumption accuracy among multiple users can be suppressed.

Moreover, values suitable for the user's current state of movement are preferably set to the coefficient a and the constant b described above. Because, when the user is in walking and in running, actual moving speeds may not necessarily become the same, even when integrated angle information is the same.

Accordingly, the information acquisition part 130 may judge the state of movement of the user based on the angle information, obtain movement state information representing the state of movement, and switch the coefficient a and the constant b to be used, according to the obtained movement state information.

There are a variety of methods of judging the state of movement. First, as preconditions, acceleration vectors in each of the states of movement will be described, using schematic graphs in FIG. 7A and FIG. 7B. The graph of FIG. 7A shows a locus TR1 drawn by acceleration vectors when the user is walking in the Z axis direction, and the graph of FIG. 7B shows a locus TR2 drawn by acceleration vectors when the user is running in the Z axis direction. It is assumed that, each time the user steps forward by one step, the locus (TR1, TR2) of acceleration vectors shown in each of FIG. 7A and FIG. 7B can be observed periodically. Moreover, both of FIG. 7A and FIG. 7B illustrate an exemplary case where the locus of acceleration vectors generally draws the shape of letter “8”, but the locus of acceleration vectors might draw another different shape.

As shown in FIG. 7A and FIG. 7B, the acceleration vectors draw a larger locus in the running state than in the walking state, because the shaking of the body in the right and left direction and the up and down direction is more violent in the running state. In other words, the integrated angle obtained based on acceleration vectors that can be detected in the period during which the user steps forward his foot by one step (from lifting of the foot to landing thereof on the ground) becomes greater in the running state than in the walking state. This is synonymous to the case where, when the integrated angle information is represented in a graph in FIG. 8 to be described later, the inclination of the graph becomes greater in the running state than in the walking state.

Therefore, the information acquisition part 130 may compare the amount of change per unit time of the integrated angle information with a predetermined threshold to judge the state of movement of the user, and obtain movement state information that represents the state of movement.

The amount of change per unit time of the integrated angle θₛᵤₘ is, for example, an inclination of a graph shown in FIG. 8 where the integrated angle (integrated angle information) is presented in the graph. Note here that FIG. 8 is a graph showing the integrated angle versus the sampling time. The sampling time (here, 100 sampling time=1 second) is shown on the horizontal axis, and the integrated angle (deg) is shown on the vertical axis of the graph of FIG. 8. The integrated angle in FIG. 8 represents an accumulated value when the integration processing is performed for a predetermined period. Moreover, the integrated angle information and the integrated angle are assumed to be equal to each other in FIG. 8, for simplification of description.

In other words, the state of movement can be determined by judging as to whether the inclination of a graph like the one shown in FIG. 8 is greater than the predetermined threshold. For example, the state of running may be determined when the inclination is greater than the predetermined threshold, and the state of walking may be determined when the inclination of the graph is at the predetermined threshold or less.

Moreover, as another example, the state of movement may be judged by comparing a speed assumption value assumed last time and a predetermined threshold. For example, when the speed assumption value is greater than a predetermined threshold value for a certain period of time, the state of movement may be determined as the running state. Furthermore, the steps of the user may be detected by using the periodicity of the graph shown in FIGS. 7A and 7B, and the moved distance, etc. may be assumed. However, the method of judging the state of movement is not limited to these methods described above.

As a result, appropriate values for the coefficient a and the constant b specified according to the state of movement can be used when obtaining the speed assumption value. Accordingly, variations in the speed assumption accuracy among different states of movement can be suppressed.

Naturally, as the coefficient a and constant b, values different in each user and each state of movement may not necessarily be used, and common values may be used in all cases.

Moreover, the state detection device 100 of the embodiment may include a calibration processing part 150 that performs calibration based on the measured speed value may be included. Then, the information acquisition part 130 may change at least one of the values among the coefficient a and the constant b based on the result of the calibration processing.

As a result, for example, the state detection device 100 of the embodiment can decide the coefficient a and the constant b without depending on an external device. Therefore, when the user uses the device, the trouble of purposely preparing another device or the like to perform the calibration processing can be saved, and thus the convenience can be further improved.

Next, an example of a method of mounting the state detection device 100 in accordance with the embodiment on the electronic apparatus 900 (a method of arranging constituting components) is described by using FIG. 9A and FIG. 9B. FIG. 9A shows the top surface of a first electronic substrate 700 included in the electronic apparatus 900, and FIG. 9B shows the back surface of the first electronic substrate 700. To avoid confusion in the illustration, a frame that shows the first electronic substrate 700 is illustrated being separated from a frame that shows the electronic apparatus 900 in FIG. 9A and FIG. 9B. However, they actually coincide with each other. This similarly applies to a second electronic substrate 800 to be described later.

First, the electronic apparatus 900 of the embodiment may include a state detection device 100, and an acceleration sensor 200.

Also, the electronic apparatus 900 of the embodiment may include a state detection device 100, an acceleration sensor 200, a wireless communication part 400, an antenna part 300, and a battery 500 (a battery socket).

For example, the electronic apparatus 900 may be a pedometer. Note that the reference numeral 600 denotes heart rate measurement electrode terminals, and may be mounted if necessary. In the present embodiment, the heart rate measurement electrode terminals 600 may be omitted.

Here, the wireless communication part 400 controls communications between the state detection device 100 and the antenna part 300. The wireless communication part 400 can be realized by hardware, such as, various processors (CPU, etc.) and ASIC (gate array, etc.) and programs.

Moreover, the antenna part 300 is a device that radiates (transmits) high frequency energy as electric wave (electromagnetic radiation) in the space or, conversely, converts (receives) electric wave (electromagnetic radiation) in the space into high frequency energy. Note that the antenna part 300 of the embodiment at least has a transmission function. In addition, a single antenna part 300 or a plurality of antenna parts 300 may be installed for the electronic apparatus 900. For example, when a plurality of antenna parts 300 are installed, each of the antenna parts may have a different caliber.

However, when the acceleration sensor 200 and the antenna part 300 are mounted on the same substrate, an error may occur in the detection result of the acceleration sensor 200 due to influence by the electric wave (electromagnetic radiation) emitted from the antenna part 300. For this reason, in the past, the acceleration sensor 200 and the antenna part 300 are separated and mounted on independent substrates, respectively, to prevent errors from occurring in the detection result of the acceleration sensor 200. However, in such a case, the electronic apparatus 900 becomes large due to the combined thickness of the substrates, which leads to a problem in that, the electronic apparatus 900, if installed on the chest or the like during exercise, would hinder the exercise.

Therefore, in accordance with the embodiment as shown in FIG. 9A and FIG. 9B, the state detection device 100, the acceleration sensor 200, the wireless communication part 400, and the battery 500 are mounted on the first electronic substrate 700, the acceleration sensor 200 may be mounted on a first direction DR1 side of the wireless communication part 400, and the antenna part 300 may be mounted on a second direction DR2 side of the wireless communication part 400.

Note here that the second direction DR2 is a direction different from the first direction DR1, and may be, for example, a generally opposite direction to the first direction DR1, as shown in FIG. 9A.

As a result, the acceleration sensor 200 and the antenna part 300 can be mounted, separated from each other, which makes it more difficult for errors, which may be caused by electric wave emitted from the antenna part 300, to occur in the detection result of the acceleration sensor 200.

In addition, by mounting the state detection device 100, the acceleration sensor 200, the wireless Communication part 400, the antenna part 300, and the battery 500 on a single substrate, the electronic apparatus 900 can be made more compact. As a result, the electronic apparatus 900, even when installed on the chest, etc. in exercise, would not hinder the exercise.

Moreover, in the electronic apparatus 900, the antenna part 300 may be mounted on the second electronic substrate 800 that is installed in the first direction side of the wireless communication part 400.

It is preferable to exclude a substrate pattern on the back surface of the second electronic substrate 800. Moreover, the second electronic substrate 800 may preferably be disposed on the first electronic substrate 700, superposed at the edge thereof, as shown in FIG. 9A and FIG. 9B. However, without any limitation to the above, for example, only a part of the first electronic substrate 700 may be superposed on the second electronic substrate 800.

As a result, the acceleration sensor 200 and the antenna part 300 can be mounted further apart from each other, which makes it even more difficult for errors, which may be caused by electric wave emitted from the antenna 300, to occur in the detection result of the acceleration sensor 200.

Moreover, in the electronic apparatus 900, the state detection device 100, the acceleration sensor 200, and the wireless communication part 400 may be mounted on the top surface of the first electronic substrate 700, and the battery 500 may be mounted on the back surface of the first electronic substrate 700.

As a result, the electronic apparatus 900 can be made much thinner.

Also, a measurement system in accordance with an embodiment of the invention may include the state detection device 100.

For example, a measurement system including the electronic apparatus described above may be enumerated as an example of such a measurement system, in which a part or all of the functions of the state detection device 100 may be realized by a server connected through the antenna part 300, the wireless communication part 400 and a communication system.

As a result, for example, a part of the processing performed by the state detection device 100 may be executed by the server, whereby the amount of processing by the state detection device 100 can be reduced.

A portion or a majority of the processings of the state detection device 100, etc. in accordance with the present embodiment may be realized by a program. In this case, a processor such as a CPU executes the program, whereby the state detection device 100, etc., of the embodiment are realized. Concretely, the program stored in an information storage medium is read, and a processor such as a CPU executes the program read out. Here, the information storage medium (e.g., a computer-readable medium) stores programs and data, and its function can be achieved by an optical disk (a DVD, a CD, etc.), a HDD (a hard disk drive) or a memory (a card type memory, a ROM, etc.) and the like. Then, the processor such as a CPU performs various processings according to the present embodiment based on the program (data) stored in the information storage medium. In other words, the information storage medium stores programs to render a computer (a device that has an operation part, a processing part, a storage part, and an output part) to function as each of the parts of the embodiment (in other words, programs that render the computer to execute the processing of each of the parts parts).

### 4. Processing Flow

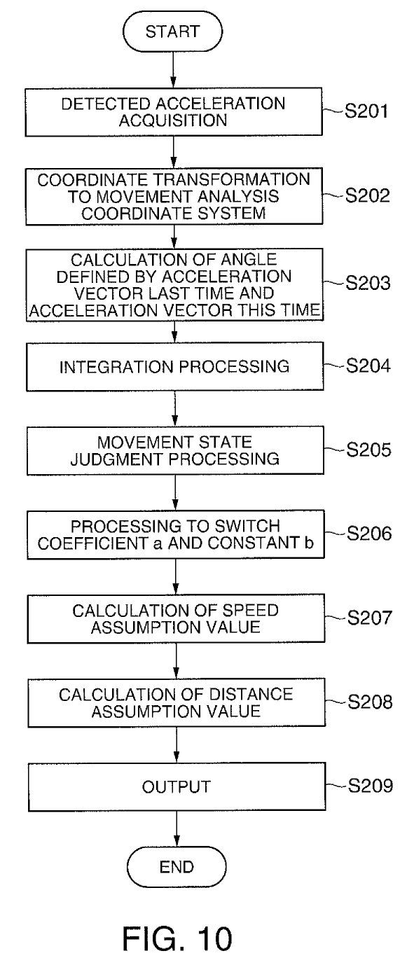

The processing flow of the embodiment will be described below, using a flow chart of FIG. 10. Note that the angle information and the angle are assumed to be equal to each other in FIG. 10 for simplification of description, without any particular limitation thereto.

First, detected acceleration is acquired from the acceleration sensor (S201). At this time, the detected acceleration acquired from the acceleration sensor is represented by a value in an acceleration sensor coordinate system. Therefore, a processing for coordinate transformation of the detected acceleration is performed to transform the acceleration sensor coordinate system to a movement analysis coordinate system (S202).

Next, acceleration vectors that represent the detected acceleration after coordinate transformation are obtained, and an angle defined between an acceleration vector obtained this time and an acceleration vector obtained last time is calculated (S203). Specifically, the processing in Expression (7) described above is performed.

Then, the integration processing for a plurality of the angles obtained in a predetermined period is performed (S204). Specifically, the processing in Expression (8) is performed.

Here, based on the detected acceleration, the judgment processing to judge the state of movement of the user is performed (S205). Then, based on the result of the judgment processing to judge the state of movement, the processing to switch the coefficient a and the constant b is performed (S206).

Then, as shown in Expression (9), the speed assumption value is calculated based on the integrated angle and the coefficient a and the constant b (S207).

Lastly, the speed assumption value is multiplied by the travel time to calculate the distance assumption value (S208), and the result is output to the display part, the wireless communication part, or the like. (S209).

The embodiments of the invention are described above in detail. However, those skilled in the art should readily understand that many modifications can be made without departing in substance from the novel matter and effects of the invention. Accordingly, all of those modified examples are deemed to be included in the scope of the invention. For example, throughout the specification and the drawings, terms described at least once with different terms in a broader sense or synonymous can be replaced with those different terms in any sections of the specification and the drawings. Moreover, the composition and the operation of the state detection device, the electronic apparatus, the measurement system, etc. are not limited to those described by the embodiment, and various modifications can be implemented.

What is claimed is:

1. A state detection device comprising:
an acquisition part that acquires detected acceleration from an acceleration sensor;
an angle information calculation part that calculates angle information based on a first acceleration vector representing the detected acceleration obtained at a first timing and a second acceleration vector representing the detected acceleration obtained at a second timing, the angle information being corresponding to an angle defined by the first acceleration vector and the second acceleration vector; and
an information acquisition part that acquires movement state information based on the angle information.

2. A state detection device according to claim 1, wherein the information acquisition part obtains a speed assumption value as one of the movement state information based on the angle information.

3. A state detection device according to claim 2, wherein the information acquisition part obtains angle information to be integrated based on the angle information corresponding to the detected acceleration obtained in a predetermined period, performs an integration processing on the obtained angle information to be integrated to obtain integrated angle information, and obtains the speed assumption value as one of the movement state information based on the integrated angle information.

4. A state detection device according to claim 3, wherein the information acquisition part compares a change per unit time of the integrated angle information with a predetermined threshold value to judge a state of movement of the user, thereby obtaining the movement state information representing the state of movement.

5. A state detection device according to claim 3, wherein the information acquisition part performs the integration processing on the angle information to be integrated obtained based on the detected acceleration acquired within the predetermined period that is longer than 2Tᵤ, where Tᵤ is a step interval of the user.

6. A state detection device according to claim 3, wherein the information acquisition part obtains, at a speed assumption timing M1, integrated angle information θ_{M1} from the sum total of integrated angle information θ_{T1}-θ_{Ti} obtained respectively at preceding speed assumption timings T1-Ti (i is a positive integer of 2 or more), and obtains, at a speed assumption timing M2, integrated angle information θ_{M2} from the sum total of integrated angle information θ_{T2}-θ_{T (i+1)} obtained respectively at preceding speed assumption timings T2-T(i+1).

7. A state detection device according to claim 3, wherein the information acquisition part obtains the speed assumption value V_{d} as the movement state information by a relational expression of V_{d}=aθₛᵤₘ+b (coefficient a and constant b are predetermined real numbers), where the integrated angle information is θₛᵤₘ, and the speed assumption value is V_{d}.

8. A state detection device according to claim 7, wherein the state detection device includes a storage part that stores the coefficient a and the constant b obtained from measured values, and the information acquisition part obtains the speed assumption value V_{d} based on the coefficient a and the constant b read out from the storage part.

9. A state detection device according to claim 7, wherein the information acquisition part judges a state of movement of the user based on the angle information, obtains the movement state information representing the state of movement, and switches the coefficient a and the constant b to be used, according to the movement state information obtained.

10. A state detection device according to claim 7, further comprising a calibration processing part that performs a calibration processing based on measured speed values, wherein the information acquisition part changes at least one of the coefficient a and the constant b based on the result of the calibration processing.

11. An electronic apparatus comprising the state detection device and the acceleration sensor recited in claim 1.

12. A measurement system comprising the state detection device recited in claim 1.

13. A program that operates a computer to function as
an acquisition part that acquires detected acceleration from an acceleration sensor;
an angle information calculation part that calculates, based on a first acceleration vector representing the detected acceleration obtained at a first timing and a second acceleration vector representing the detected acceleration obtained at a second timing, angle information corresponding to an angle defined by the first acceleration vector and the second acceleration vector; and
an information acquisition part that acquires movement state information based on the angle information.
